(19) United States
(12) Patent Application Publication
(10) Pub. No.: US 2025/0259067 A1
(43) Pub. Date: Aug. 14, 2025

(54) COMPRESSING A LARGE LANGUAGE MODEL THAT INCLUDES LOW RANK ADAPTION MODULES

(71) Applicant: Microsoft Technology Licensing, LLC, Redmond, WA (US)

(72) Inventors: Tianyi CHEN, Kenmore, WA (US); Tianyu DING, Kirkland, WA (US); Luming LIANG, Redmond, WA (US); Ilya Dmitriyevich ZHARKOV, Sammamish, WA (US)

(21) Appl. No.: 18/439,710

(22) Filed: Feb. 12, 2024

(51) Int. Cl. G06N 3/0895

(52) U.S. Cl. CPC G06N 3/0895

(57) ABSTRACT

Technologies related to compressing a large language model (LLM) that has been fine-tuned using low rank adaption are described. Minimally removable structures in the LLM are identified, and node groups are constructed based upon the identified minimally removable structures. Progressive structured pruning is employed to remove prunable variables corresponding to prunable node groups of the LLM. The pruned LLM is then fine-tuned to recover knowledge lost during pruning.

### BACKGROUND

Relatively recently, large language models (LLMs) have been developed, where the advent of LLMs marks a significant milestone in the evolution of artificial intelligence. An LLM is a type of artificial intelligence algorithm that applies neural network techniques with a large number of parameters (e.g., billions or trillions of parameters) to process and understand text in human-readable language using self-supervised learning techniques. LLMs are configured to performs tasks such as text generation, machine translation, text summarization, image generation from texts, machine coding, conversational artificial intelligence conversation, amongst others. Examples of LLMs include Chat General Pretrained Transformer 4 (GPT-4), Gemini®, BigScience Large Open-science Open-access Multilingual Language Model (BLOOM), amongst others. The enormous size of LLMs (billions to trillions of parameters) results in the incursion of substantial costs with respect to both processing and memory resources.

While several technologies have been developed to compress deep neural networks (DNNs), such technologies are not well-suited for use when compressing LLMs. For example, technologies generally referred to as “structured pruning” have been used to compress DNNs by identifying and removing redundant structures in the uncompressed DNN; knowledge encoded in the DNN that was lost during pruning can be at least partially recovered during subsequent training of the compressed DNN. Application of structured pruning on LLMs, however, faces significant challenges. With more specificity, typically LLMs are initially trained using a relatively large dataset (a pretraining dataset) and subsequently fine-tuned using a dataset that is specific to a particular application (an instruction dataset). For example, a LLM that is to be employed in connection with an airline chatbot is initially trained using a relatively large text dataset that is not specific to the airline industry and then subsequently fine-tuned using an instruction dataset that is specific to the airline industry. A pruning approach that has been adapted for use with LLMs employs low-rank adaption during pruning and/or subsequent fine-tuning stages of LLM compression; it has been observed, however, that an LLM pruned in this manner is associated with significantly reduced performance when compared to the uncompressed LLM. Other pruning approaches require a significant amount of fine-tuning training data and a large amount of graphical processing unit (GPU) resources, which is not feasible in many situations where resources are constrained.

Accordingly, there is an unmet need for technologies for compressing LLMs (thereby making the LLMs suitable for use in resource-constrained environments) without significantly degrading performance of the LLMs.

### SUMMARY

The following is a brief summary of subject matter that is described in greater detail herein. This summary is not intended to be limiting as to the scope of the claims.

Described herein are various technologies for compressing and fine-tuning LLMs. With more particularity, an LLM is obtained, and the LLM is subject to low rank adaption. More specifically, pretrained weights of the LLM are held frozen and trainable rank decomposition matrices are added to each layer of the transformer architecture of the LLM. These trainable rank decomposition matrices and corresponding linear operators are referred to herein as low rank adaption modules. Thereafter, minimally removable structures in the LLM are identified, where such structures are identified through construction of a dependency graph across groups of operators of the LLM. From these minimally removable structures, prunable variable groups are distinguished from non-prunable variable groups, where the two groups are distinguished from one another based upon estimated knowledge lost when such groups are removed from the LLM.

Progressive structured pruning is then undertaken over the prunable variable groups. In more detail, redundant structures in the prunable variable groups are identified and removed by progressively projecting such structures onto zero. In addition, knowledge stored in the redundant structures to be pruned is transferred back to counterpart structures to preserve knowledge encoded in the original LLM. Finally, knowledge lost during pruning of the LLM is restored by selecting a subset of training data from a pretraining dataset and an instruction dataset and training the LLM based upon the selected subsets. Experimentally it has been observed that utilizing the approach summarized above results in an LLM of reduced size when compared to the original LLM without a significant reduction in performance.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of a computing system that is configured to compress a LLM that includes low rank adaption modules.

FIG. 2 is a schematic that depicts a dependency graph of a portion of a LLM.

FIG. 3 is a schematic that depicts a dependency graph of another portion of the LLM.

FIG. 4 is a chart that depicts distribution of knowledge encoded across different node groups of an LLM.

FIG. 5 is a schematic illustration of Half-Space projection.

FIG. 6 is flow diagram that illustrates a method for compressing and training a LLM that includes low rank adaption modules.

FIG. 7 is a flow diagram that illustrates a method for pruning structures from a LLM.

FIG. 8 is a schematic of a computing system.

### DETAILED DESCRIPTION

Various technologies pertaining to compressing and training a LLM are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component,” “module,” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Described herein are various technologies that are configured to compress a LLM (trained both using a pretraining dataset and an instruction dataset) that was fine-tuned using low rank adaption. The compressed LLM is reduced in size by a selectable factor (which can be chosen based upon available resources to execute the LLM and desired performance of the LLM). As will be described in greater detail herein, the LLM can be compressed through use of a processing pipeline, where the processing pipeline includes at least one of: 1) discovery of minimally removable structures in the LLM; 2) identification of prunable variable groups based upon the discovery of the minimally removable structures; 3) progressive structured pruning of the LLM; and 4) dynamic knowledge recovery. Each portion of the processing pipeline is described in greater detail herein.

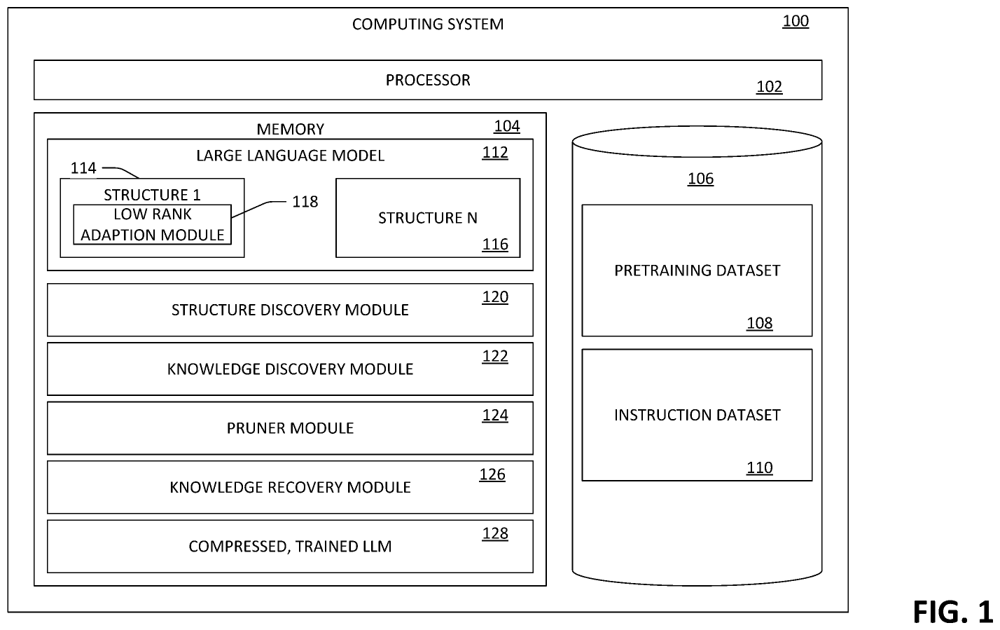

Referring now to FIG. 1, a computing system 100 that is configured to compress a trained LLM is depicted. The computing system 100 includes a processor 102, memory 104, and a data store 106, where the memory 104 stores data that is accessible to the processor 102 and instructions that are executed by the processor 102. Further, the data store 106 includes a pretraining dataset 108 and an instruction dataset 110. The pretraining dataset 108 includes text that is general in nature (i.e., the pretraining dataset 108 is not customized for any particular application). The instruction dataset 110 is specific to an application. For example, the instruction dataset can include labeled instruction-output pairs.

The memory 104 includes a trained LLM 112, where the LLM 112 has been pretrained based upon the pretraining dataset 108 and fine-tuned based upon the instruction dataset 110. Moreover, the LLM 112 has been fine-tuned using low rank adaption, which is described briefly herein. Fine-tuning a relatively large pretrained LLM is computationally challenging, often involving adjustments of millions of parameters of the LLM. Fine-tuning of the LLM, while effective in configuring the LLM to perform a particular task, requires substantial computational resources and time, posing a bottleneck for adapting the LLM to the particular task. Low rank adaption reduces computational resources required to fine-tune the LLM by decomposing an update matrix during fine-tuning.

More particularly, in traditional fine-tuning, weights of a pretrained LLM are modified to configure the LLM for the particular task, where modification of the weights involves altering an original weight matrix (W) of the LLM. The changes made to (W) during fine-tuning are collectively represented by (ΔW), such that the updated weights can be expressed as (W+ΔW). Instead of modifying W directly, using low rank adaption involved decomposition of ΔW, thereby reducing computational overhead associated with fine-tuning the LLM. It has been observed that significant changes to the LLM can be captured using a lower-dimensional representation—put differently, it has been observed that not all elements of ΔW are of equal importance; instead, modifying a smaller subset of such elements can encapsulate the necessary adjustments without significantly impacting performance of the resultant LLM. When the LLM is fine-tuned using low rank adaption, ΔW is represented as the product of two smaller matrices, (A) and (B), with a relatively low rank, and the updated weight matrix (W′) of the LLM is therefore represented as:

$$[ {W}^{′} = W + B A ] . \qquad ( 1 )$$

During fine-tuning, W remains frozen and the matrices (B) and (A) are of relatively low dimensionality, with their product (BA) representing a low-rank approximation of ΔW. By choosing matrices (A) and (B) to have a lower rank (r), the number of trainable parameters is significantly reduced.

As noted previously, the LLM 112 has been pretrained using the pretraining dataset 108 and fine-tuned using the instruction dataset 110, where low rank adaption was employed when fine-tuning the LLM 112. Hence, the LLM 112 includes several structures 114-116, where at least the first structure 114 includes a low rank adaption module 118. The low rank adaption module 118 can include a low rank matrix (e.g., at least one of matrix A or matrix B) and a corresponding operator (e.g., a linear operator, a nonlinear operator such as a sigmoid function, or the like). The first structure 114, then, can include the low rank adaption module 118 as well as other modules, such as a weight matrix, other operators, and so forth.

The memory 104 further includes a structure discovery module 120, a knowledge discovery module 122, a pruner module 124, and a knowledge recovery module 126. Briefly, the structure discovery module 120 is configured to identify minimally removable structures of the LLM 112, the knowledge discovery module 122 is configured to analyze knowledge distribution over node groups in a dependency graph of the LLM 112, the pruner module 124 is configured to perform progressive structured pruning of the LLM 112 to identify redundant structures in the LLM 112 and transfer lost knowledge to remaining structures, and the knowledge recovery module 126 is configured to train the resultant compressed LLM to recover lost knowledge. An algorithm collectively performed by the modules 120-126 is set forth below:

Algorithm 1: Outline of Processing Pipeline

1: Input. Pretrained LLM [symbol] .
2: Discover minimal removal structures of [symbol] by creating and analyzing
dependency graph ( [symbol] , [symbol] ). Partition trainable variables of [symbol] into [symbol] .
3: Analyze knowledge distribution over each node group in the
dependency graph.
4: Progressive structured pruning to identify redundant structures and
transfer lost knowledge.
5: Construct compressed model to erase redundancy from compressed
compact LLM [symbol] *.
6. Output the compact high-performing LLM [symbol] *.

Additional detail is now set forth with respect to operations performed by the modules 120-126. As referenced above, the structure discovery module 120 is configured to identify minimally removable structures of the LLM 112. A minimally removable structure is a unit that can removed from the LLM 112 without affecting functionality of remaining units in the LLM 112. In connection with identifying minimally removable structures in the LLM 112, the structure discovery module 120 obtains or constructs a trace graph of the LLM 112. The structure discovery module 120 then identifies composed operators in the trace graph, where a composed operator includes multiple basic operators that are to be considered as a single operator (such as low rank adaption modules that include two linear operators). The structure discovery module 120 then constructs node groups based upon identified composed operators.

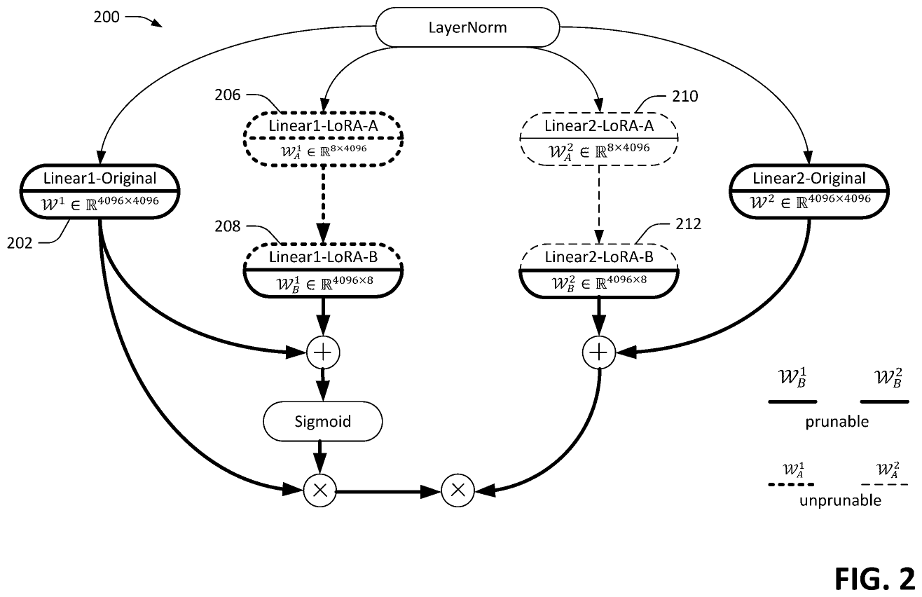

Referring briefly to FIG. 2, a schematic that illustrates a dependency graph 200 for multilayer perceptron (MLP) layers of the LLM 112 is presented, where the dependency graph 200 includes representations of numerous operators, including original operators 202 and 204 of the LLM 112 after being generally trained but prior to fine-tuning and low rank adaption operators 206-212 introduced during fine-tuning of the LLM 112 using low rank adaption. The structure discovery module 120 identifies the operators 206 and 208 as being a first composed operator and identifies the operators 210 and 212 as being a second composed operator. The structure discovery module 120 identifies first node groups based upon the composed operators, where each node group in the first node groups includes at least one composed operator. An operator within one composed operator may be simultaneously included in multiple node groups in the first node groups; this is because outgoing operators of composed operators still need to obey dependencies across other adjacent operators in the trace graph. Therefore, for example, in FIG. 2 the low rank adaption operator 208 is included in two separate node groups in the first node groups. Second node groups are identified, where node groups in the second node group include remaining operators (operators not identified as composed operators). Based upon the identification of the first node groups and the second node groups, the structure discovery module 120 partitions the trainable variables of the LLM 112 into a set of groups, where each group within the set of groups corresponds to one minimally removable structure.

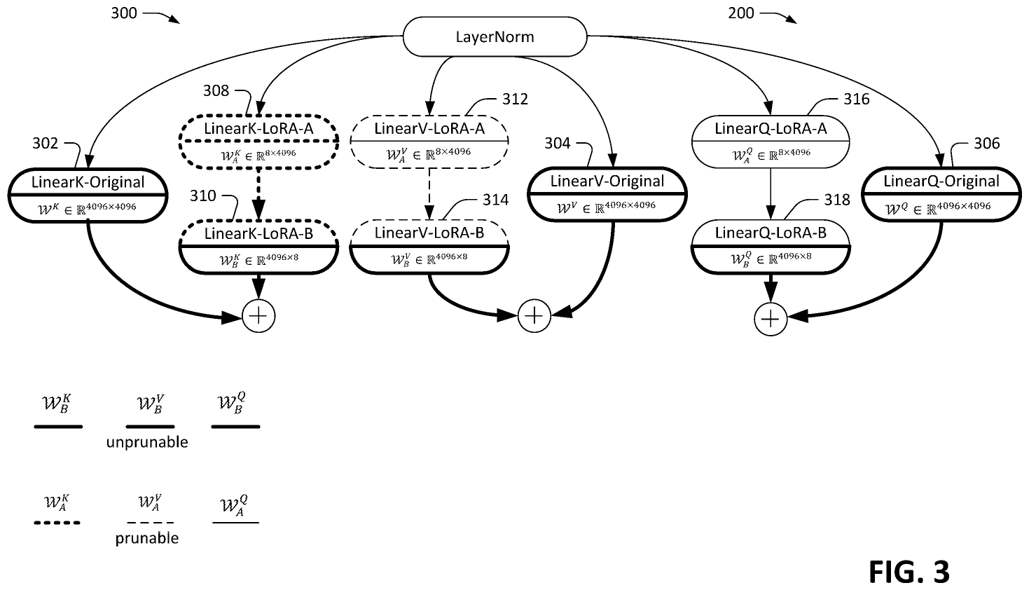

With reference to FIG. 3, a schematic that illustrates a dependency graph 300 for attention layers of the LLM 112 is presented. The dependency graph 300 includes representations of original operators 302-306 and low rank adaption operators 308-318. The structure discovery module 120 identifies the operators 308-310 as being a first composed operator, identifies the operators 312-314 as being a second composed operator, and identifies the operators 316-318 as being a third composed operator. The structure discovery module 120 identifies first node groups based upon the identified composed operators, where each node group in the first node groups includes at least one operator in a composed operator. As shown in FIG. 3, a first node group in the first node groups includes operators 308-310, while a second node group in the first node groups includes operators 310 and 314. The structure discovery module 120 identifies second node groups, where each node group in the second nodes groups includes at least one original operator. In summary, the purpose of the structure discovery module 120 is to identify groups of operators that can be removed without impacting operation of other operators of the LLM 112.

An example algorithm that can be executed by the structure discovery module 120 is set forth below.

Algorithm 2: Minimally Removal Structure Discovery

1: input. A LLM [symbol] with low rank adaption modules to be compressed and
fine-tuned.
2: construct the trace graph ( [symbol] , [symbol] ) of [symbol] .
3: establish node groups [symbol] _{composed} for composed operators by traversing
(E, V) and the module tree of [symbol] .
4: establish node groups [symbol] _{basic} for remaining operators.
5: build dependency across [symbol] _{composed} and [symbol] _{basic}.
6: partition trainable variables into minimally removal structures and form [symbol]
.
7: return the trainable variable groups [symbol] .

Returning to FIG. 1, the knowledge discovery module 122 is configured to analyze knowledge distribution over node groups in the dependency graph of the LLM 112. With more specificity, due to the universal training process, the knowledge encoded in the LLM 112 is unevenly distributed across all of the node groups in the dependency graph constructed by the structure discovery module 120. Thus, some node groups encode significantly more knowledge than other node groups, and thus if a node group that encodes a relatively large amount of knowledge is pruned from the LLM 112, performance of the resultant (compressed) LLM will be significantly impacted. Moreover, retraining the compressed LLM after loss of knowledge is not guaranteed to recover such knowledge in resource-constrained environments. The knowledge discovery module 122 estimates the loss of knowledge for prunable node groups prior to such node groups being pruned, thereby allowing the knowledge discovery module 122 to identify node groups that encode a relatively large amount of knowledge, and thus identify the node groups as those that should not be pruned from the LLM 112. The knowledge discovery module 122 identifies trainable variables of such node groups as unprunable.

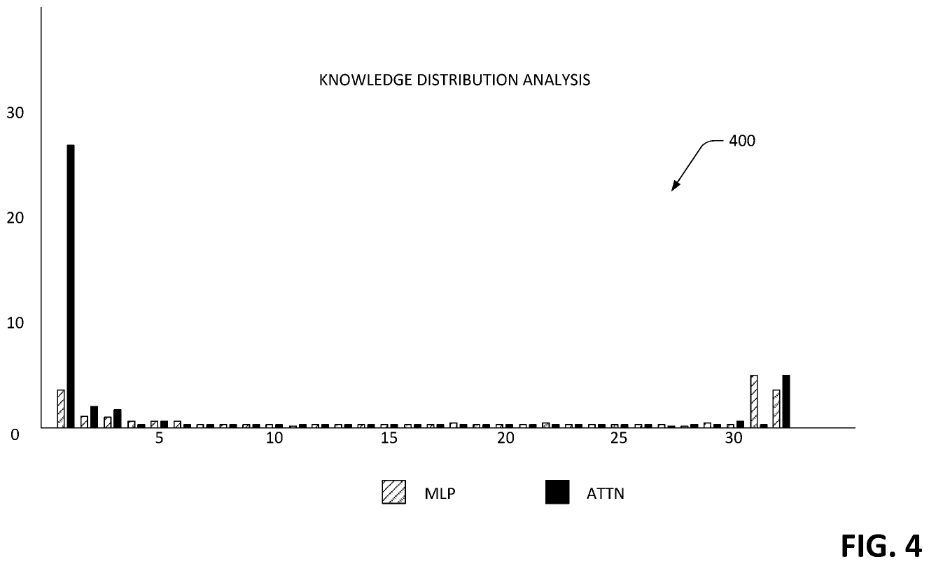

With reference now to FIG. 4, a bar graph 400 depicting distribution of knowledge across node groups is presented. As can be ascertained, a relatively large amount of knowledge is encoded in first, thirty first, and thirty second node groups; the knowledge discovery module 122 computes values depicted in FIG. 4 and labels trainable variables corresponding to the high knowledge node groups as being unprunable.

An example algorithm that can be executed by the knowledge discovery module 122 is set forth below.

Algorithm 2: Knowledge Discovery

| | |
|---|---|
| 1: | input. Trainable variable partition [symbol] , node groups [symbol] _{composed} ∪ |

[symbol]

_{basic}, a set of pruning ratios [symbol] , an evaluation dataset [symbol] ₑᵥₐₗ, and an
unprunable ratio γ.

| | |
|---|---|
| 2: | for each node group in [symbol] _{composed} ∪ [symbol] _{basic}, do: |
| 3: | prune groups upon a specified proxy and [symbol] . |
| 4: | compute performance deviation upon [symbol] ₑᵥₐₗ. |
| 5: | recover pruned groups to the original status. |
| 6: | end for |
| 7: | sort the performance deviation over [symbol] _{composed} ∪ [symbol] _{basic}. |
| 8: | mark the groups in [symbol] corresponding to the node groups with the |

largest deviation upon γ as unprunable: [symbol] _{unprunable}.

| | |
|---|---|
| 9: | mark the remaining groups in [symbol] as prunable: [symbol] _{prunable}. |
| 10: | return prunable and unprunable variable groups [symbol] _{prunable} ∪ |
| | [symbol] _{unprunable}. |

Returning again to FIG. 1, the pruner module 124 is configured to perform progressive structured pruning of the LLM 112 (based upon the prunable and unprunable variable groups identified by the knowledge discovery module 122), identify redundant structures, and transfer lost knowledge to remaining structures. With more specificity, the pruner module 124 performs progressive structured pruning over the prunable groups of variables [symbol] _{prunable}. The pruner module 124 can utilize an algorithm (referred to as a Low rank adaption Half-Space Projected Gradient (LHSPG) algorithm) to yield structured sparsity over the original model parameters (i.e., W) based on optimization information over low rank adaption modules in the LLM 112. The pruner module 124, when executing the LHSPG algorithm, 1) identifies and removes redundant structures by projecting them onto zero; and 2) transfers the knowledge stores in the relatively redundant structures to be pruned back to the important counterparts to better preserve the knowledge of the LLM 112.

Progressive structured pruning can be formulated as the following structured sparsity problem over LLMs with low rank adaption modules:

$${min}_{,} f ( , ) , s . t . Card \{ g ∈ {p r u n a b l e}_{} \vert {[ x ]}_{g} = 0 \} = K ,$$

where [symbol] and [symbol] are the collections of low rank adaption decomposing sub-matrices, which are trainable during structured pruning. It is desirable to yield group sparsity over the original variables with the target sparsity level as K.

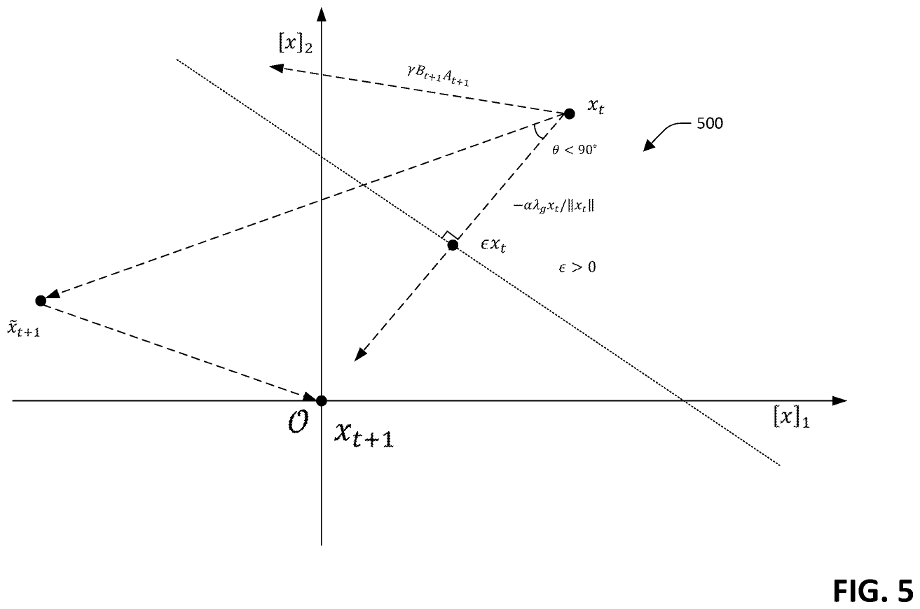

In operation, the pruner module 124 warms up low rank adaption variables in the prunable groups [symbol] _{prunable} identified by the knowledge discovery module 122 by way of stochastic gradient descent (or a variant thereof) to obtain gradient information. The pruner module 124 then progressively identifies redundant structures within P periods of sparse optimization—to proceed, the pruner module 124 computes the target group sparsity level to be produced for each period p. In each period p, the pruner module 124 sorts the prunable groups upon prespecified saliency proxies and picks up the prunable groups with least saliency scores as redundant groups for the current period: [symbol] ₚ. The pruner module 124 then computes a trial iterate over the low rank adaption variables in [symbol] and [symbol] by way of stochastic gradient descent (or variants thereof). For the redundant groups [symbol] ₚ, the pruner module 124 proceeds with performing a gradient descent by way of low rank adaption approximation and penalized over the variable magnitude proportionally to λ_{g}, which is selected based upon length of each pruning period. The pruner module 124 next performs a Half-Space projection over the trial iterate to project groups of variables associated with the least sacrificing over the object function. During this process, the pruner module 124 progressively projects redundant groups onto zero; during such projection, the low rank adaption modules for the important counterparts absorb knowledge by way of minimizing the loss functions. Therefore, through progressive structured pruning, the pruner module 124 not only effectively identifies and projects redundant groups of variables onto zero, but also preserves the knowledge stored in the redundant structures (to a large extent). The pruner module 124 outputs a final iterate. Referring briefly to FIG. 5, a plot 500 depicts a Half-Space step over low rank adaption modules.

An algorithm that can be executed by the pruner module 124 is as follows:

Algorithm 4: Progressive Structured Pruning via LHSPG

```
  1: input - pretraining variable x₀, learning rate α, warm-up steps T_{w},
  progressive period P, period length Tₚ, target sparsity level K, and vari-
  able partition [symbol] _{prunable} ∪ [symbol] _{unprunable}.
  2: warm up T_{w} steps via stochastic gradient descent or a variant thereof.
  3: initialize redundant groups [symbol] _{redundant} ← Ø.
  4: initialize important groups [symbol] ᵢₘₚₒᵣₜₐₙₜ ← [symbol] .
  5: compute sparsity level for each pruning period \hat{K} := K/Tₚ.
  6: for each pruning period p = 0, 1, ... , P − 1, do
  7: pickup [symbol] ₚ in [symbol] ᵢₘₚₒᵣₜₐₙₜ with \hat{K}-least saliency scores.
  8: update [symbol] _{redundant} ← [symbol] _{redundant} ∪ [symbol] ₚ.
  9: update [symbol] ᵢₘₚₒᵣₜₐₙₜ ← [symbol] _{redundimportantant}/ [symbol] ₚ.
10: for t = 0,1, ... , Tₚ - 1, do
11: update low rank adaption [symbol]  and [symbol]  by way of stochastic
          gradient descent or variants thereof: [symbol]
ₜ₊₁ ← [symbol] ₜ − αₖ [symbol]  f [symbol]
ₜ₊₁ ← [symbol] ₜ − α_{K} [symbol] f
12: compute trial iterate [\hat{x}ₜ₊₁ [symbol]  for each g ∈ [symbol] ₚ.
${[ {\hat{x}}_{t + 1} ]}_{g} ← {[ {x}_{t} + {γℬ}_{t + 1} {𝒜}_{t + 1} ]}_{g} - \frac{{{λ}_{g} [ {x}_{t} ]}_{g}}{‖ {[ {x}_{t} ]}_{g} ‖}$
13: perform Half-Space projection over [\hat{x}ₜ₊₁ [symbol] .
14: update [xₜ₊₁ [symbol]  ← [xₜ₊₁ [symbol] .
15: update [ [symbol] ₜ₊₁ [symbol]  ← 0.
16: if t = Tₚ − 1 then
17: merge [ [symbol] ₁₊₁ [symbol] ₜ₊₁ [symbol]  into [x [symbol]  .
18: end if
19: end for
20: end for
21: return the final iterate x_{LHSPG}*.
```

Given the returned final iterate, the pruner module 124 constructs a structurally pruned LLM [symbol] by erasing structures corresponding to the redundant groups in [symbol] _{prunable}. The pruner module 124 can perform such process by way of two pass dependency graph traversal—the first-pass traversal iterates each node group and prunes the structures along the primary dimension, while the second-pass traversal erases the structures along the secondary dimension upon the pruned status of the incoming structures.

Returning again to FIG. 1, the knowledge recovery module 126 is configured to train the structurally pruned LLM [symbol] to recover lost knowledge. A trained LLM (e.g., the LLM 112) acquires knowledge through a two-stage process: 1) pretraining on extensive and diverse text corpora, followed by 2) fine-tuning with specific instruction dataset. The acquired knowledge is encoded as variable values within the LLM 112; however, at least some of such variables may be pruned by the pruner module 124. The knowledge recovery module 126 is configured to perform a post-training process to recover knowledge lost during pruning, where the post-training process involves both the pretraining 108 and fine-tuning 110 datasets.

Due to the vast and diverse nature of the pretraining dataset 108, conventional structured pruning approaches for pruning LLMs use only the instruction dataset 110 to recover lost knowledge post-pruning. Failing to utilize the pretraining dataset 108 to recover lost knowledge of an LLM (caused by pruning), however, has been observed to lead to significant degradation in performance. To address such issue, the knowledge recovery module 126 can sample subsets from both the pretraining dataset 108 and the instruction dataset 110 and update variables of the compressed LLM, thereby forming the compressed, trained LLM 128. In more detail, the knowledge recovery module 126 can select subsets from the pretraining dataset 108 and the instruction dataset 110 based upon an evaluation dataset, thereby ensuring that a significant amount of knowledge is recovered. In an example, the knowledge recovery module 126 can execute the following algorithm:

Algorithm 5: Dynamic Knowledge Recovery

| | |
|---|---|
| 1: | input. Pretraining dataset [symbol] _{pretraining}, instructed fine-tuning dataset |

[symbol]

_{instruct}, and the pruned LLM [symbol] .

| | |
|---|---|
| 2: | establish validation datasets for [symbol] _{pretraining} and [symbol] _{instruct} as [symbol] _{pretraining}^{val} |

and [symbol] _{instruct}^{val}, respectively.

| | |
|---|---|
| 3: | for [symbol] ∈ { [symbol] _{pretraining}, [symbol] _{instruct}}, do |
| 4: | while not converge do |
| 5: | dynamically construct \hat{D} ⊆ [symbol] by evaluation. |
| 6: | fine-tune [symbol] with low rank adaption on \hat{D}. |
| 7: | end while |
| 8: | end for |
| 9: | return knowledge-recovered pruned LLM [symbol] |

From the foregoing, it can be ascertained that the knowledge recovery module 126 uniformly samples from the pretraining and instruction fine-tuning datasets [symbol] _{pretraining} and [symbol] _{instruct} to form the validation datasets [symbol] _{pretraining}^{val} and [symbol] _{instruct}^{val}, respectively. The knowledge recovery module 126 then evaluates the performance degradation of [symbol] over different sources therein by way of [symbol] _{pretraining}^{val}. Based upon the performance degradation distribution over the different sources, the knowledge recovery module 126 constructs a subset of the pretraining data \hat{D}_{pretraining} ⊆ [symbol] _{pretraining}. The criteria used by the knowledge recovery module 126 for selecting samples within [symbol] _{pretraining} involves prioritizing sources (categories) that experience more significant performance degradation while ensuring a balanced representation of samples from sources with less performance degradation to prevent overfitting. The knowledge recovery module 126 then employs low rank abstraction for fine-tuning the pruned model based upon \hat{D}_{pretraining}. If the evaluation results do not converge, the knowledge recovery module 126 repeats the process of constructing a next subset of data from [symbol] _{pretraining} until convergence is achieved. Following the knowledge recovery from the pretraining state, the knowledge recovery module 126 applies the same methodology to [symbol] _{instruct}; experimentally it has been observed that this iterative approach yields a relatively high performing pruned LLM [symbol] (the trained, compressed LLM 128). Specifically, it has been observed that utilizing the technologies disclosed herein, the trained, compressed LLM 128 significantly outperforms conventional LLM pruning technologies when a 20% and 50% compression ratio was used to compress an LLM (e.g., by 2.2-5%) while only differing from an uncompressed LLM by 1% when a 20% pruning ratio is employed.

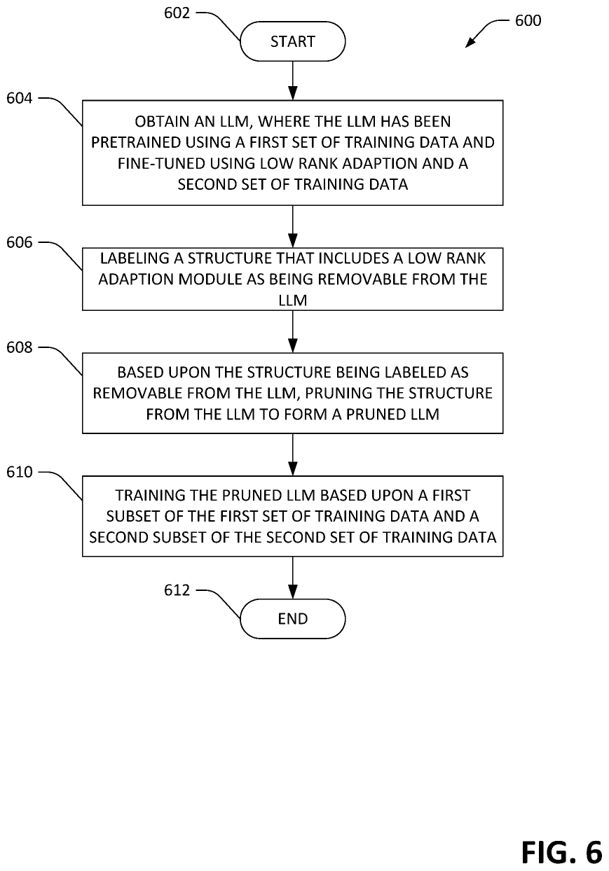

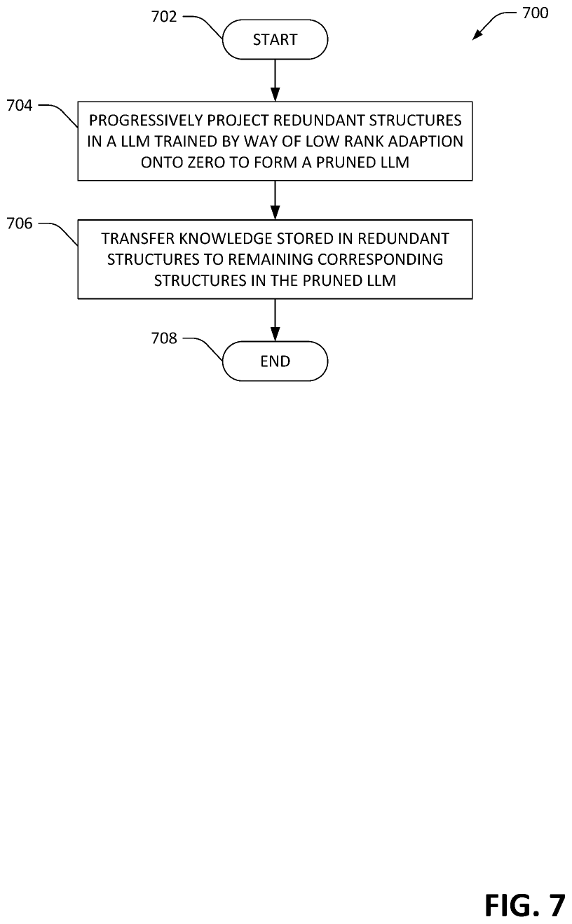

FIGS. 6 and 7 illustrate methodologies relating to compressing a LLM that includes low rank adaption modules. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring solely to FIG. 6, a method 600 for pruning and training a LLM that includes a low rank adaption module is illustrated. The method 600 starts at 602, and at 604 an LLM is obtained. The obtained LLM has been pretrained using a first set of training data (e.g., a pretraining dataset) and has been fine-tuned using a second set of training data (e.g., an instruction dataset). Further, the obtained LLM was fine-tuned using low rank adaption, such that the obtained LLM includes a low rank adaption module that was introduced into the LLM during fine-tuning.

At 606, a structure that includes a low rank adaption module is labeled as being removable from the LLM. This is a non-trivial task, as the LLM includes fixed weights that are not to be updated as well as low rank adaption modules that include updatable variables. Specifically, labeling a low rank adaption module as being removable includes constructing a dependency graph of the obtained LLM, identifying minimally removal structures based upon the dependency graph, computing knowledge distribution over node groups that are formed based upon the minimally removable structures to identify node groups that are not to be pruned from the LLM, and progressively pruning node groups to identify which node groups are to be finally pruned from the LLM.

At 608, based upon the structure being labeled as removable from the LLM, the structure is pruned from the LLM to form a pruned LLM. At 610, the pruned LLM is trained based upon a first subset of the first training data and a second subset of the second set of training data. In an example, low rank adaption can be used to train the pruned LLM based upon the first subset of the first training data and the second subset of the second training data. The output of the method 600 is a trained, compressed LLM. In an example, the trained, compressed LLM has a size that is approximately 20% of the size of the LLM obtained at 604. In another example, the trained, compressed LLM has a size that is approximately 30% of the size of the LLM obtained at 604. In still yet another example, the trained, compressed LLM has a size that is approximately 50% of the size of the LLM obtained at 604. The method 600 completes at 612.

With reference to FIG. 7, a method 700 related to compressing and training a LLM to form a compressed, trained LLM is depicted, where the LLM includes a low rank adaption module. The method 700 starts at 702, and at 704 redundant structures in the LLM are progressively projected onto zero (e.g., the structures are projected onto zero in steps to preserve knowledge encoded in the redundant structures). At 706, knowledge encoded in the progressively pruned redundant structures is transferred to remaining corresponding structures in the pruned LLM, such that the resultant compressed, trained LLM preserves the knowledge that would otherwise have been lost due to pruning. The method 700 completes at 708.

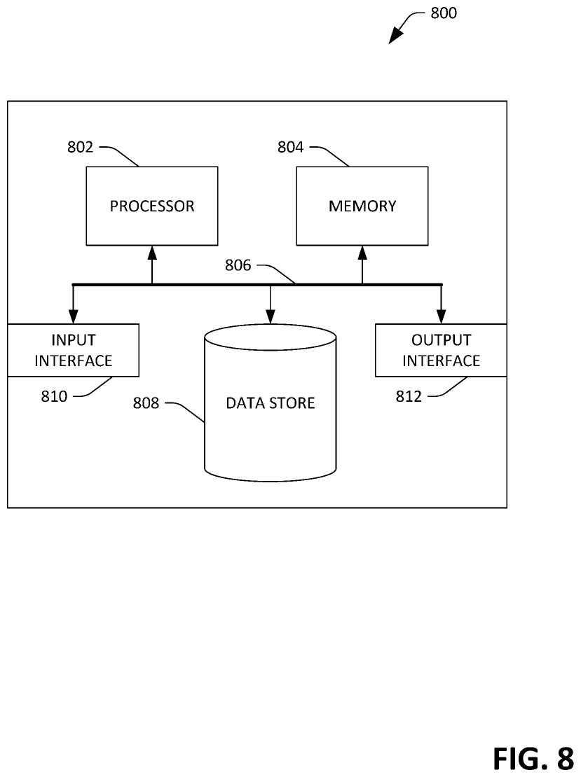

Referring now to FIG. 8, a high-level illustration of an exemplary computing device 800 that can be used in accordance with the systems and methodologies disclosed herein is illustrated. For instance, the computing device 800 may be used in a system that compresses a LLM with a low rank adaption module to form a trained, compressed LLM. By way of another example, the computing device 800 can be used in a system that executes a compressed LLM. The computing device 800 includes at least one processor 802 that executes instructions that are stored in a memory 804. In an example, the processor is a graphics processing unit (GPU), although other processor types are contemplated. The instructions may be, for instance, instructions for implementing functionality described as being carried out by one or more components discussed above or instructions for implementing one or more of the methods described above. The processor 802 may access the memory 804 by way of a system bus 806. In addition to storing executable instructions, the memory 804 may also store at least a portion of an LLM, weight matrices of the LLM, etc.

The computing device 800 additionally includes a data store 808 that is accessible by the processor 802 by way of the system bus 806. The data store 808 may include executable instructions, pretraining data, instruction training data, etc. The computing device 800 also includes an input interface 810 that allows external devices to communicate with the computing device 800. For instance, the input interface 810 may be used to receive instructions from an external computer device, from a user, etc. The computing device 800 also includes an output interface 812 that interfaces the computing device 800 with one or more external devices. For example, the computing device 800 may display text, images, etc. by way of the output interface 812.

It is contemplated that the external devices that communicate with the computing device 800 via the input interface 810 and the output interface 812 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 800 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 800 may be a distributed system. Thus, for instance, several devices may be in communication by way of a network connection and may collectively perform tasks described as being performed by the computing device 800.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computing system comprising:
a processor; and
memory storing instructions that, when executed by the processor, cause the processor to perform acts comprising:
obtaining a large language model (LLM) that has been pretrained based upon first training data and fine-tuned based upon second training data, where the LLM includes a structure that comprises a low rank adaption module having variables with values learned when the LLM was fine-tuned based upon the second set of training data;
identifying that the structure is within a set of removable structures in the LLM;
based upon identifying that the structure is within the set of removable structures in the LLM, pruning the structure from the LLM in connection with forming a compressed LLM; and
tuning the compressed LLM based upon a first subset of the first training data and a second subset of the second training data.

2. The computing system of claim 1, where identifying that the structure is within the set of removable structures comprises constructing a dependency graph that identifies dependencies between structures in the LLM, where the structure is identified as being within the set of removable structures based upon the dependency graph.

3. The computing system of claim 2, the acts further comprising identifying a group of variables of the LLM based upon the dependency graph, where the structure includes the variables with values learned when the LLM was fine-tuned based upon the second set of training data.

4. The computing system of claim 2, where constructing the dependency graph comprises:
constructing a trace graph of the LLM;
establishing first node groups for composed operators of the LLM, where the first node groups are established by traversing the trace graph and a module tree of the LLM; and
establishing second node groups for remaining operators of the LLM, where the dependency graph is built across the first node groups and the second node groups.

5. The computing system of claim 4, the acts further comprising:
subsequent to identifying that the structure is within a set of removable structures of the LLM and prior to pruning the structure from the LLM:
for each node group in the first node groups and the second node groups:
pruning a node group from the LLM based upon a previously defined pruning ratio to form a pruned LLM; and
computing a value that is indicative of performance of the pruned LLM when provided with an evaluation dataset, wherein the structure is pruned from the LLM based upon the value that is indicative of performance assigned to the node group that includes the structure.

6. The computing system of claim 5, further comprising computing a distribution of performance values over the first node groups and the second node groups, where the structure is pruned from the LLM based upon the distribution of performance values.

7. The computing system of claim 1, the acts further comprising pruning structures from the LLM to facilitate retention of knowledge in remaining structures of the LLM, where the pruned structure is included within the structures that are pruned from the LLM.

8. The computing system of claim 7, where pruning the structures of the LLM comprises progressively projecting redundant structures onto zero.

9. The computing system of claim 8, the acts further comprising transferring knowledge from the pruned structure back to a counterpart structure in the compressed LLM.

10. The computing system of claim 6, further comprising identifying that the structure is redundant in the LLM, where the structure is pruned from the LLM due to the structure being identified as redundant in the LLM.

11. A method for compressing a large language model (LLM), the method comprising:
obtaining the LLM, where the LLM has been pretrained using a first set of training data and fine-tuned for an application using a second set of training data that differs from the first set of training data, and further where the LLM includes a structure that comprises a low rank adaption module introduced into the LLM in connection with fine-tuning the LLM;
labeling the structure as being removable from the LLM;
based upon the structure being labeled as removable from the LLM, pruning the structure from the LLM to form a pruned LLM; and
training the pruned LLM based upon a first subset of the first set of training data and a second subset of the second set of training data to form a compressed and trained LLM.

12. The method of claim 11, further comprising:
training the LLM using the first dataset; and
fine-tuning the LLM for the application using the second dataset.

13. The method of claim 11, where the LLM, prior to being compressed, includes 100 billion parameters, and further where the structure is pruned from the LLM based upon a compression ratio specified for compressing the LLM.

14. The method of claim 11, where labelling the structure as being removable comprises constructing a dependency graph that identifies dependencies between structures in the LLM, where the structure is identified as being within a set of removable structures based upon the dependency graph.

15. The method of claim 14, further comprising identifying a group of variables of the LLM based upon the dependency graph, where the structure includes variables in the identified group of variables.

16. The method of claim 14, where constructing the dependency graph comprises:
constructing a trace graph of the LLM;
establishing first node groups for composed operators of the LLM, where the first node groups are established by traversing the trace graph and a module tree of the LLM; and
establishing second node groups for remaining operators of the LLM, where the dependency graph is built across the first node groups and the second node groups.

17. The method of claim 16, further comprising:
subsequent to identifying that the structure is within a set of removable structures of the LLM and prior to pruning the structure from the LLM:
for each node group in the first node groups and the second node groups:
pruning a node group from the LLM based upon a previously defined pruning ratio to form a pruned LLM; and
computing a value that is indicative of performance of the pruned LLM when provided with an evaluation dataset, wherein the structure is pruned from the LLM based upon the value that is indicative of performance assigned to the node group that includes the structure.

18. A computer-readable storage medium comprising instructions that, when executed by a processor, cause the processor to perform acts comprising:
obtaining a large language model (LLM) that has been pretrained based upon first training data and fine-tuned based upon second training data, where the LLM includes a structure that comprises a low rank adaption module;
identifying that the structure is within a set of removable structures in the LLM;
based upon identifying that the structure is within the set of removable structures in the LLM, pruning the structure from the LLM in connection with forming a compressed LLM; and
updating values of unpruned low rank adaption modules in the compressed LLM based upon a first subset of the first training data and a second subset of the second training data.

19. The computer-readable storage medium of claim 18, where identifying that the structure is within the set of removable structures comprises constructing a dependency graph that identifies dependencies between structures in the LLM, where the structure is identified as being within the set of removable structures based upon the dependency graph.

20. The computer-readable storage medium of claim 19, the acts further comprising identifying a group of variables of the LLM based upon the dependency graph, where the structure includes variables in the identified group of variables.
